(19) United States
(12) Patent Application Publication
(10) Pub. No.: US 2026/0084960 A1
(43) Pub. Date: Mar. 26, 2026

(54) AUTOTHERMAL REFORMING PROCESS FOR PRODUCTION OF HYDROGEN

(71) Applicant: Topsoe A/S, Kgs. Lyngby (DK)

(72) Inventors: Per Juul DAHL, Vedbæk (DK); Arunabh SAHAI, Haryana (IN); Thomas Sandahl CHRISTENSEN, Kgs. Lyngby (DK); Steffen Spangsberg CHRISTENSEN, Køge (DK)

(73) Assignee: Topsoe A/S, Kgs. Lyngby (DK)

(21) Appl. No.: 19/111,555

(22) PCT Filed: Sep. 15, 2023
(86) PCT No.: PCT/EP2023/075458

§ 371 Date: Mar. 13, 2025

(30) Foreign Application Priority Data
Sep. 16, 2022 (IN) 202211053164
Feb. 10, 2023 (EP) 23156049.1

(51) Int. Cl. C01B 3/38; C01B 3/48; C01B 3/50

(52) U.S. Cl. CPC C01B 3/38; C01B 3/48; C01B 3/50; C01B 2203/0244; C01B 2203/0283; C01B 2203/0833; C01B 2203/1058; C01B 2203/1241; C01B 2203/1258

(57) ABSTRACT

A hydrogen plant and process for production of a hydrogen stream are provided. The hydrogen plant comprises a steam superheater, arranged to superheat at least a portion of a first steam stream from a steam drum, and thereby provide a superheated steam stream via heat exchange with a first shifted syngas stream. At least a first portion of said superheated steam stream is arranged to heat the first stream comprising hydrocarbons before said first stream is fed to the prereformer unit. In this manner, the use of fired heaters, or electrical heaters, can be reduced or avoided.

### TECHNICAL FIELD

The present invention relates to the field of hydrogen plants and processes for production of a hydrogen stream. The hydrogen plant of the invention comprises a steam superheater, arranged to superheat at least a portion of a first steam stream from a steam drum, and thereby provide a superheated steam stream. At least a first portion of said superheated steam stream is arranged to heat the first stream comprising hydrocarbons before said first stream is fed to the prereformer unit.

### BACKGROUND

Standard process layouts for hydrogen plants (e.g., the SynCOR™ process from Topsoe A/S) typically include a fired heater to preheat the hydrocarbon feed to the desulphurization section, hydrocarbon feed plus steam to the pre-reformer and pre-reformed gas to the autothermal reformer (ATR).

Significant efforts have been put into optimizing production for hydrogen plants, with the objective to improve overall energy efficiency and reduce capital cost. The need for more cost-efficient hydrogen production has spurred the development of technology and catalysts for large-scale hydrogen production units, in order to benefit from economy of scale. Efforts have also been made to reduce greenhouse gas outputted from such plants.

It would be advantageous to reduce—among other things—the CO₂ emissions from hydrogen plants. WO2022038089 describes a plant for producing a hydrogen-rich stream from a hydrocarbon feed. Other publications in this field include U.S. Pat. No. 11,498,834 B1 and Consonni S et al. International Journal of Hydrogen Energy, 30, 7, 1 Jul. 2005, pages 701-718.

It is an object of the present invention to reduce consumption of hydrocarbon feed and fuel in a hydrogen plant and/or process, thereby increasing energy efficiency. At the same time, it is an object to reduce CO₂ emissions in a hydrogen plant and/or process. The carbon footprint of the plant can thereby be significantly reduced.

These and other objects are addressed by the present invention.

### SUMMARY

It has surprisingly been found that by only using internally generated superheated steam a revised plant and process can be provided in which a fired heater is not required during normal operation. Significantly reduced steam export is also achieved, as is a low steam/carbon ratio of the syngas from the ATR unit. Overall, an excellent economy of scale is achieved.

So, in a first aspect the present invention relates to a hydrogen plant, said plant comprising:
a first stream comprising hydrocarbons;
a second stream comprising an oxidant;
a prereformer unit arranged to receive the first stream comprising hydrocarbons and provide a prereformed stream;
an autothermal reforming (ATR) unit arranged to receive the prereformed stream and the second stream comprising an oxidant, and to provide a first syngas stream;
a first waste heat boiler arranged to provide a first steam stream via a steam drum;
a hydrogen synthesis and purification section arranged to receive at least said first syngas stream and to provide a hydrogen stream and at least one off-gas stream;
   wherein the hydrogen synthesis and purification section comprises a high temperature shift reactor; arranged to receive at least a portion of said first syngas stream and provide a first shifted syngas stream;
   wherein the hydrogen plant further comprises a steam superheater, arranged to superheat at least a portion of the first steam stream from said steam drum, via heat exchange with the first shifted syngas stream from the high temperature shift reactor, and thereby provide a superheated steam stream, and
   wherein the hydrogen plant further comprises a second heat exchanger (210) arranged to heat said first stream (1) comprising hydrocarbons via heat exchange with at least a first portion of said superheated steam stream (62), before said first stream (1) is fed to the prereformer unit (30).

A process is also provided for production of a hydrogen stream in the hydrogen plant defined herein.

Further details of the technology are provided in the enclosed dependent claims, FIGURES and examples.

### LEGENDS TO THE FIGURE

The technology is illustrated by means of the following schematic illustration(s), in which:

FIG. 1 shows a layout of the hydrogen plant of the invention.

(1) first stream comprising hydrocarbons
(1a) heated first stream comprising hydrocarbons
(2) a second stream comprising an oxidant
(3) third feed comprising hydrogen
(4) . . . .
(5) a first gas feed comprising hydrocarbons
(6) hydrocarbon feed gas, comprising hydrocarbons
(9) atmospheric air
(30) prereformer unit
(31) prereformed stream
(39) air separation unit
(40) autothermal reforming (ATR) unit
(41) a first syngas stream
(42) internal steam feed
(43) optionally internal steam stream
(50) high temperature shift reactor
(51) first shifted syngas stream
(52) cooled shifted syngas stream
(55) low temperature shift reactor
(60) steam drum
(61) first steam stream
(62) superheated steam stream
(64) superheated steam stream
(65) export steam
(70) hydrogenation section
(71) hydrogenated feed gas
(80) sulfur removal unit
(81) hydrogenated desulfurized feed gas
(90) first waste heat boiler
(101) hydrogen stream
(102) off-gas stream
(110) steam superheater
(190) second waste heat boiler
(210) second heat exchanger
(220) first heat exchanger
(230) separator
(231) process condensate 231 (comprising mostly water)
(240) CO2 removal section
(241) CO2-rich stream
(250) pressure-swing adsorption (PSA) unit
(500) hydrogen plant

### DETAILED DISCLOSURE

Unless otherwise specified, any given percentages for gas content are % by volume.

For the avoidance of doubt, the term “feed” refers to means for supplying said gas to the appropriate section, stage, reactor or unit; such as a duct, tubing etc.

A “section” comprises one or more “units” which perform a change in the chemical composition of a feed, and may additionally comprise elements such as e.g., heat exchanger, mixer or compressor, which do not change the chemical composition of a feed or stream.

The term “synthesis gas” (abbreviated to “syngas”) is meant to denote a gas comprising hydrogen, carbon monoxide, carbon dioxide, steam and small amounts of other gasses, such as argon, nitrogen, methane, etc.

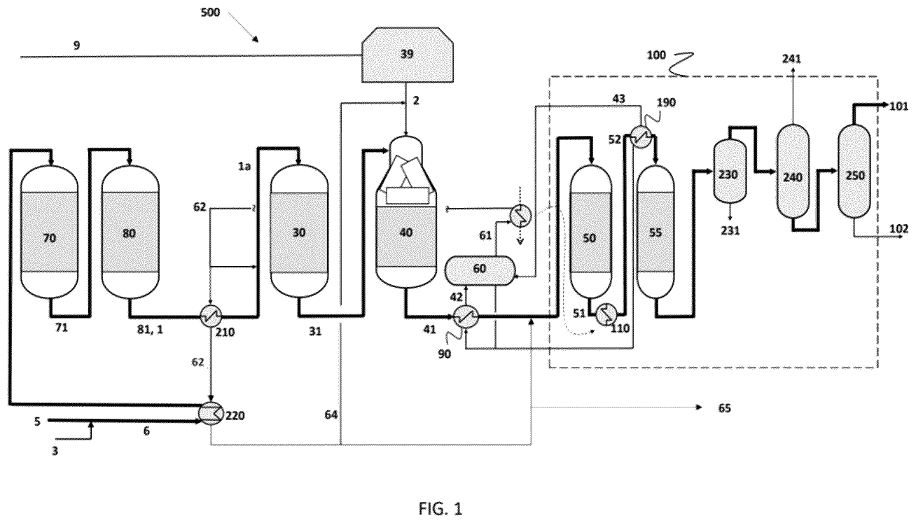

The invention provides a hydrogen plant as described above and as shown schematically in FIG. 1.

A first stream comprising hydrocarbons is provided. This first stream suitably comprises a major portion (e.g. over 80%, such as over 90%) methane. Higher hydrocarbons (with >2 carbon atoms) may also be present. The first stream is suitably derived from a natural gas feed, which has been pre-treated, e.g. via hydrogenation and sulfur removal.

A second stream comprising an oxidant is also provided, suitably to the ATR unit. Suitably, the oxidant feed consists essentially of oxygen. The oxidant feed of O₂ is suitably “O₂ rich” meaning that the major portion of this feed is O₂; i.e. over 75% such as over 90% or over 95%, such as over 99% of this feed is O₂. This oxidant feed may also comprise other components such as nitrogen, argon, CO₂, and/or steam. This oxidant feed will typically include a minor amount of steam (e.g. 2-10%). The source of oxidant feed, oxygen, can be at least one air separation unit (ASU) and/or at least one membrane unit. The source of oxygen can also be at least one electrolyser unit. The oxidant feed of O₂ may come from at least one electrolyser, which converts steam or water into hydrogen and oxygen by use of electrical energy. Steam may be added to the oxidant feed comprising oxygen, upstream the ATR section.

A prereformer unit is arranged to receive the first stream comprising hydrocarbons and provide a prereformed stream. Pre-reforming is the process by which methane and heavier hydrocarbons are steam reformed and the products of the heavier hydrocarbon reforming are methanated. The adiabatic pre-reformer is usually positioned upstream of the main steam reformer and uses a catalyst with high nickel content. A prereformed stream therefore comprises CO, CO₂, and CH₄.

An autothermal reforming (ATR) unit is arranged to receive the prereformed stream (from the prereformer unit) as well as the second stream comprising an oxidant, and provides a first syngas stream from these streams. An ATR unit typically comprises a burner, a combustion chamber, and a catalyst bed contained within a refractory lined pressure shell. In an ATR unit, partial combustion of hydrocarbons by sub-stoichiometric amounts of oxygen is followed by steam reforming i.e. the reverse of reaction (1) and (2) of the partially combusted hydrocarbons in a fixed bed of steam reforming catalyst.

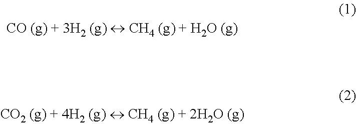

Steam reforming also takes place to some extent in the combustion chamber due to the high temperature. The steam reforming reaction is accompanied by the water gas shift reaction. Typically, the gas is at or close to equilibrium at the outlet of the reactor with respect to steam reforming and water gas shift reactions. More details of ATR and a full description can be found in the art such as “Studies in Surface Science and Catalysis, Vol. 152,” Synthesis gas production for FT synthesis”; Chapter 4, p. 258-352, 2004”.”.

Typically, the effluent gas stream from the ATR reactor, i.e. the first synthesis gas stream, has a temperature of 900-1100° C. The synthesis gas normally comprises hydrogen, carbon monoxide, carbon dioxide, and steam. Other components such as methane, nitrogen, and argon may also be present often in minor amounts. The operating pressure of the ATR reactor will be between 5 and 100 bars or more preferably between 15 and 60 bars.

The plant is arranged to provide an inlet temperature of said hydrocarbon feed to the ATR of below 650° C., such as 550° C. or 500° C. or lower, for instance 300-400° C. The above temperatures are lower than the typical ATR inlet temperatures of 600-700° C. and which are normally desirable to reduce oxygen consumption in the ATR. Hence, the plant is purposely and counterintuitively arranged for having a lower ATR inlet temperature. By having a lower ATR inlet temperature, suitably 550° C. or lower, such as 500° C. or lower, e.g. 300-400° C., the amount of heat required in a heater unit for preheating the hydrocarbon, e.g. a fired heater, is significantly reduced, thereby enabling a much smaller fired heater, or reducing the number of fired heaters. By having an inlet temperature to the ATR of 300-400° C., the use of a fired heater can be completely obviated as well. Another benefit is reduced CO₂ emission from a fired heater.

The hydrogen plant comprises a first waste heat boiler arranged to provide a first steam stream via a steam drum. The steam drum receives steam from the first and—optionally—second waste heat boiler. Typically, the steam stream from the steam drum is provided in the range 25-130 barg and 225-300° C.

The downstream section of the plant is a hydrogen synthesis and purification section. The hydrogen synthesis and purification section is arranged to receive at least said first syngas stream and to provide a hydrogen stream and at least one off-gas stream. The hydrogen synthesis and purification section typically comprises (in order): High temperature (HT) shift reactor, steam superheater, low temperature (LT) shift reactor, second waste heat boiler, separator, CO₂ removal section and pressure-swing adsorption (PSA) unit.

In particular, the hydrogen synthesis and purification section comprises a high temperature (HT) shift reactor, arranged to receive at least a portion of the first syngas stream and provide a first shifted syngas stream. The first shifted syngas stream is provided from the HT shift reactor at a temperature in the range 420-480° C.

The hydrogen plant further comprises a steam superheater (in the form of a heat exchanger). The steam superheater is arranged to superheat at least a portion of the first steam stream from said steam drum, via heat exchange with the first shifted syngas stream from the high temperature shift reactor, and thereby provide a superheated steam stream. In this way, the first steam stream from the steam drum is heated from a temperature of 255-330° C. to a temperature of 400-450° C. The steam drum is suitably arranged to receive an internal steam feed (i.e. from elsewhere in the same plant) or an external steam feed (i.e. from outside the plant). Preferably the steam drum is arranged to receive an internal steam feed.

In one aspect, the hydrogen plant further comprises a first waste heat boiler (WHB). The WHB is arranged downstream the ATR unit, and is arranged to provide an internal steam feed via heat exchange with at least a portion of the first syngas stream from the ATR unit. By recycling energy in this manner, optimal use of available energy is ensured.

The superheated steam stream may be used in a variety of pre-heating procedures, and thus reduce or avoid the use of fired or electrical heaters. According to the invention, at least a first portion of the superheated steam stream is arranged to heat the first stream comprising hydrocarbons, before said first stream is fed to the prereformer unit.

The superheated steam stream may also be arranged to heat at least a portion of a hydrocarbon feed gas provided to the plant, before said feed gas is fed to the hydrogenation section. In particular, therefore, the hydrogen plant further comprises a second heat exchanger arranged to heat said first stream comprising hydrocarbons via heat exchange with at least a first portion of said superheated steam stream, before said first stream is fed to the prereformer unit.

Additionally, it may be possible that at least a portion of said superheated steam stream is arranged to heat at least a portion of the second stream comprising an oxidant before said portion of said second stream is fed to the autothermal reforming (ATR) unit. Preferably, heating of the second stream comprising an oxidant by the superheated steam stream is carried out by mixing the superheated steam stream with at least a portion of the second stream comprising an oxidant. The mixed stream is then fed to the autothermal reforming (ATR) unit

The heating sequence of the superheated steam stream may also be relevant, in that streams/sections with a higher temperature requirement are heated first, followed by streams/sections with a lower temperature requirement. In one aspects, shown in FIG. 1, a first portion of the superheated steam stream is arranged to heat at least a portion of the first stream comprising hydrocarbons before said first stream is fed to the prereformer unit; and this portion of the superheated steam stream is subsequently arranged to heat at least a portion of the hydrocarbon feed gas, before said hydrocarbon feed gas is fed to the hydrogenation section. Furthermore, a portion (which may be the same portion, or a different portion as that used to heat the first stream comprising hydrocarbons) of said superheated steam stream is-optionally-subsequently arranged to heat at least a portion of the second stream comprising an oxidant (e.g. by mixing) before said portion of said second stream is fed to the autothermal reforming (ATR) unit. Excess superheated steam may be exported from the plant.

The hydrogen plant may comprise one or more units upstream the prereformer unit. In one aspect, the hydrogen plant comprises a sulfur removal unit arranged upstream the prereformer unit, and a hydrogenation section arranged upstream the sulfur removal unit. The hydrogenation section is arranged to receive a hydrocarbon feed gas—provided by mixing first hydrocarbon-containing gas feed (typically a natural gas feed) with a third feed gas comprising hydrogen (typically an internal hydrogen rich stream)—and to provide a hydrogenated gas feed. The hydrogenated feed gas is arranged to be fed to the sulfur removal unit. The sulfur removal unit is arranged to receive the hydrogenated feed gas, and to provide a hydrogenated desulfurized feed gas to the prereformer unit, as said first stream comprising hydrocarbons.

It has been found that the heat which can be provided from the superheated steam can be sufficient to pre-heat the various streams as required. Accordingly, heater units, such as fired heaters can be avoided in normal operation, thus reducing the CO₂ emissions of the plant. Accordingly, in one aspect, the hydrogen plant does not comprise any heater unit arranged to be used in normal operation, such as a fired heater unit or electrical heater unit, arranged to heat at least a portion of said first stream comprising hydrocarbons before said first stream is fed to the prereformer unit. In a further aspect, the hydrogen plant does not comprise any heater unit, arranged to be used in normal operation, such as a fired heater unit or electrical heater unit, arranged to heat first hydrocarbon-containing gas feed. In yet a further aspect, the hydrogen plant does not comprise any heating means, arranged to be used in normal operation, such as a heater unit, such as a fired heater unit or electrical heater unit, arranged to heat the prereformed stream before said first stream is fed to the ATR unit. In fact, using the present invention, all heating of the prereformed stream between the prereformer unit and the ATR unit can be avoided during normal operation. Use of one or more heater units to heat the various streams during startup or shutdown may be possible.

The superheated steam stream can also be used to heat the prereformer. In this aspect, at least a portion of the superheated steam is arranged to be mixed with the first stream comprising hydrocarbons upstream the inlet of the pre-reformer unit.

The superheated steam stream can also be used to heat the first syngas stream downstream the first waste heat boiler. In this aspect, at least a portion of the superheated steam is arranged to be mixed with the first syngas stream downstream the first waste heat boiler.

The hydrogen plant may further optionally comprise a second waste heat boiler arranged downstream the steam superheater. The second waste heat boiler is arranged to recover heat from the first shifted syngas stream and thereby provide additional steam to the steam drum.

A process is also provided for production of a hydrogen stream in a hydrogen plant according to the invention. In general terms, the process comprises the steps of:
providing the hydrogen plant according to any one of the preceding claims;
feeding at least a portion of said first stream comprising hydrocarbons to the prereformer unit and providing a prereformed stream;
feeding the prereformed stream and the second stream comprising an oxidant to the autothermal reforming (ATR) unit and providing a first syngas stream;
providing a first steam stream from the first waste heat boiler via the steam drum;
feeding at least a portion of said first syngas stream to the hydrogen synthesis and purification section and providing a hydrogen stream and at least one off-gas stream;

The hydrogen synthesis and purification section comprises a high temperature shift reactor, such that the process comprises the additional steps:
feeding at least a portion of said first syngas stream to the high temperature shift reactor and providing a first shifted syngas stream;
superheating at least a portion of the first steam stream from said steam drum in the steam superheater via heat exchange with the first shifted syngas stream to provide a superheated steam stream;
heating at least a portion of said first stream (1) comprising hydrocarbons in said second heat exchanger (210) by means of heat exchange with the superheated steam stream (62), before said first stream (1) is fed to the prereformer unit (30).

All details of the plant provided above are equally relevant for the process of the invention, mutatis mutandis.

Suitably, the first stream is heated to a temperature of 440° C. degrees or lower, preferably 410° C. degrees or lower, more preferably 350-400° C., at the inlet of the prereformer unit. The process may additionally comprise a step of adding at least a portion of the superheated steam stream to at least a portion of the second stream comprising an oxidant, thereby reaching a temperature of e.g. 350° C. or higher, before said mixed stream is fed to the ATR unit.

In the particular aspect, where the hydrogen plant comprises a sulfur removal unit arranged upstream the prereformer unit, and a hydrogenation section arranged upstream the sulfur removal unit, where said hydrogenation section is arranged to receive a hydrocarbon-containing feed gas and to provide a hydrogenated feed gas which is arranged to be fed to the sulfur removal unit, and wherein said sulfur removal unit is arranged to receive said hydrogenated feed gas, and to provide a hydrogenated desulfurized feed gas to said prereformer unit as said first stream comprising hydrocarbons; the process may further comprise a step of:
heating at least a portion of the hydrocarbon feed gas, by means of the superheated steam stream, preferably to a temperature of 350° C. or higher, before said feed gas is fed to the hydrogenation section.

The purification section partially or fully removes the components CO₂, CO, CH₄, H₂O, N₂ and Ar (but not limited to these) from the shifted syngas. This section may therefore comprise one or more of the steps: amine wash, cryogenic separation, pressure swing absorption and methanation.

### SPECIFIC EMBODIMENTS

The following description of FIG. 1 is provided, showing hydrogen plant 500, with hydrogen synthesis and purification section 100. A first hydrocarbon-containing gas feed 5 (e.g. a natural gas feed) is mixed with hydrogen feed 3 to provide combined hydrocarbon feed gas 6, which is pre-heated to ca. 380° C. by means of first heat exchanger 220, heat for which is provided by superheated steam stream 62. The heated combined feed gas 6 is sent to hydrogenation section 70 in which a hydrogenated feed gas 71 is formed, and then to a sulfur removal unit 80 to provide a hydrogenated desulfurized feed gas 81 (=first stream 1 comprising hydrocarbons). The first stream 1 comprising hydrocarbons is heated (e.g. to a temperature of ca. 400° C.) in second heat exchanger 210, heat for which is also provided by superheated steam stream 62, before being fed as heated first stream 1a to the prereformer unit 30.

To provide the required heating effect, the superheated steam stream is first used to heat the first stream 1, and subsequently used to heat the first hydrocarbon-containing gas feed 5, as shown.

Atmospheric air 9 is separated in air separation unit 39 to provide an oxygen feed (=oxidant feed 2). The oxygen feed 2 is optionally heated in a steam condenser (not shown) and mixed with a portion of the (cooled) superheated steam stream 62, before being fed to the ATR unit 40.

In the ATR unit 40, the heated first stream 1 and the oxygen feed are reacted to provide a first syngas stream 41. First waste heat boiler 90 is arranged downstream the ATR unit 40, and provides an internal steam feed 42 for the steam drum 60 via heat exchange of a boiler water stream from the steam drum 60 with the first syngas stream 41 from the ATR unit 40.

Steam drum 60 is arranged to dry the steam by separating liquid water, and provide a first steam stream 61 as required. The steam drum is supplied with boiler feed water (not shown) corresponding to the steam production and boiler water purge (not shown).

A portion of the superheated steam stream is—in the illustrated embodiment—also to be mixed with the first syngas stream 41 downstream the first waste heat boiler. High temperature (HT) shift reactor 50 receives the first syngas stream 41 downstream the first waste heat boiler 90 and provides a first shifted syngas stream 51. Steam superheater 110 is arranged downstream the HT shift reactor, and superheats the first steam stream 61 from the steam drum 60 via heat exchange with the first shifted syngas stream 51 from the HT shift reactor 50. A superheated steam stream 62 is thus produced, which is used elsewhere in the plant 500, as described.

Downstream the superheater 110, the shifted syngas stream is subsequently fed to the low temperature (LT) shift reactor 55 for further shifting. Second waste heat boiler 190 is located between HT and LT shift reactors, as shown to generate second internal steam feed 43 for the steam drum 60 via heat exchange of a boiler water stream from the steam drum 60 with the cooled, shifted syngas stream 52 downstream steam superheater 110.

After the LT shift, the product gas is passed to separator 230 in which process condensate 231 (comprising mostly water) is removed. Following this, the product gas is passed to CO₂ removal section 240, where CO₂ is removed in the form of CO₂-rich stream 241. The product gas is passed to a pressure-swing adsorption (PSA) unit 250 for separation of hydrogen stream 101 and off gas stream 102, which can be exported as fuel.

### Example 1

The calculation of energy and mass balance is carried out according to FIG. 1 and key results are illustrated in below table 1:

| | | |
|---|---|---|
| NG feed flow (# 5) | Nm3/h | 85420 |
| H₂ production (# 101) | Nm3/h | 200000 |
| Steam to Carbon ratio u/s | mol/mol | 0.52 |
| Prereformer (# 30) | | |
| Total steam generation (# 61) | kg/h | 205069 |
| Duty of steam heater (# 210) | Gcal/h | 1.85 |
| u/s Prereformer | | |
| Duty of NG heater (# 220) | Gcal/h | 12.8 |
| u/s Hydrogenator | | |
| Inlet temp to Hydrogenator (# 70) | ° C. | 380 |
| Inlet temp to Prereformer (# 30) | ° C. | 407 |

The present invention has been described with reference to a number of aspects and FIGURES. However, the skilled person is able to select and combine various aspects within the scope of the invention, which is defined by the appended claims. All documents referenced herein are incorporated by reference.

1. A hydrogen plant, said plant comprising:
a first stream comprising hydrocarbons;
a second stream comprising an oxidant;
a prereformer unit arranged to receive the first stream comprising hydrocarbons and to provide a prereformed stream;
an autothermal reforming unit arranged to receive the prereformed stream and the second stream comprising an oxidant, and to provide a first syngas stream;
a first waste heat boiler arranged to provide a first steam stream via a steam drum;
a hydrogen synthesis and purification section arranged to receive at least said first syngas stream and to provide a hydrogen stream and at least one off-gas stream;
wherein the hydrogen synthesis and purification section comprises a high temperature shift reactor, arranged to receive at least a portion of said first syngas stream and provide a first shifted syngas stream;
wherein the hydrogen plant further comprises a steam superheater, arranged to superheat at least a portion of the first steam stream from said steam drum, via heat exchange with the first shifted syngas stream from the high temperature shift reactor, and thereby provide a superheated steam stream, and
wherein the hydrogen plant further comprises a second heat exchanger arranged to heat said first stream comprising hydrocarbons via heat exchange with at least a first portion of said superheated steam stream, before said first stream is fed to the prereformer unit.

2. The hydrogen plant according to claim 1, wherein said steam drum is arranged to receive an internal steam feed and optionally internal steam stream or an external steam feed.

3. The hydrogen plant according to claim 2, further comprising a first waste heat boiler arranged downstream the ATR unit, said waste heat boiler arranged to provide said internal steam feed via heat exchange with at least a portion of the first syngas stream from the ATR unit.

4. The hydrogen plant according to claim 1, further comprising a second waste heat boiler arranged downstream the steam superheater, said waste heat boiler arranged to provide said internal steam feed via heat exchange with at least a portion of the syngas stream from the steam superheater.

5. The hydrogen plant according to claim 1, wherein at least a portion of said superheated steam stream is mixed with the second stream comprising an oxidant before said second stream is fed to the autothermal reforming unit.

6. The hydrogen plant according to claim 1, wherein the hydrogen plant comprises a sulfur removal unit arranged upstream said prereformer unit, and a hydrogenation section arranged upstream said sulfur removal unit, said hydrogenation section being arranged to receive a hydrocarbon feed gas and to provide a hydrogenated gas feed which is arranged to be fed to the sulfur removal unit, and wherein said sulfur removal unit is arranged to receive said hydrogenated feed gas, and to provide a hydrogenated desulfurized feed gas to said prereformer unit as said first stream comprising hydrocarbons.

7. The hydrogen plant according to claim 6, wherein the superheated steam stream is arranged to heat at least a portion of the hydrocarbon feed gas, before said feed gas is fed to the hydrogenation section.

8. The hydrogen plant according to claim 5, wherein at least a first portion of said superheated steam stream is arranged to heat at least a portion of said first stream comprising hydrocarbons before said first stream is fed to the prereformer unit; and wherein said first portion of the superheated steam stream is subsequently arranged to heat at least a portion of the hydrocarbon feed gas, before said hydrocarbon feed gas is fed to the hydrogenation section, and wherein—optionally—a portion of said cooled superheated steam stream is subsequently arranged to be mixed with at least a portion of the second stream comprising an oxidant before said portion of said second stream is fed to the autothermal reforming unit.

9. The hydrogen plant according to claim 8, wherein the hydrocarbon feed gas is a mixture of a third feed comprising hydrogen and a first hydrocarbon gas feed.

10. The hydrogen plant according to claim 9, wherein the first hydrocarbon-containing gas feed is a natural gas feed.

11. The hydrogen plant according to claim 1, wherein the hydrogen plant does not comprise any heater unit arranged to be used in normal operation, such as a fired heater unit or electrical heater unit, arranged to heat at least a portion of said first stream comprising hydrocarbons before said first stream is fed to the prereformer unit.

12. The hydrogen plant according to claim 1, wherein the hydrogen plant does not comprise any heater unit to be used in normal operation, such as a fired heater unit or electrical heater unit, arranged to heat first hydrocarbon-containing gas feed.

13. The hydrogen plant according to claim 1, wherein the hydrogen plant does not comprise any heating means to be used in normal operation, such as a heater unit arranged between the prereformer unit and the ATR unit.

14. The hydrogen plant according to claim 1, wherein at least a portion of the superheated steam is arranged to be mixed with the first stream-comprising hydrocarbons upstream the inlet of the pre-reformer unit.

15. A process for production of a hydrogen stream in a hydrogen plant according to claim 1, said process comprising the steps of:
providing the hydrogen plant;
feeding at least a first portion of said first stream comprising hydrocarbons to the prereformer unit and providing a prereformed stream;
feeding the prereformed stream and the second stream comprising an oxidant to the autothermal reforming unit and providing a first syngas stream;
providing a first steam stream from the first waste heat boiler via the steam drum;
feeding at least a portion of said first syngas stream to the hydrogen synthesis and purification section and providing a hydrogen stream and at least one off-gas stream;
wherein the hydrogen synthesis and purification section comprises a high temperature shift reactor such that the process comprises the additional steps:
feeding at least a first portion of said first syngas stream to the high temperature shift reactor and providing a first shifted syngas stream;
superheating at least a portion of the first steam stream from said steam drum in the steam superheater via heat exchange with the first shifted syngas stream to provide a superheated steam stream; and
heating at least a portion of said first stream comprising hydrocarbons in said second heat exchanger by means of heat exchange with the superheated steam stream, before said first stream is fed to the prereformer unit.

16. The process according to claim 15, wherein the first stream is heated to a temperature of 440° C. degrees or lower, at the inlet of the prereformer unit.

17. The process according to claim 15, where the process additionally comprises a step of mixing at least a portion of the superheated steam stream with said second stream comprising an oxidant, before said second stream is fed to the ATR unit.

18. The process according to claim 15, wherein the hydrogen plant comprises a sulfur removal unit arranged upstream said prereformer unit, and a hydrogenation section arranged upstream said sulfur removal unit, said hydrogenation section being arranged to receive a hydrocarbon-containing feed gas and to provide a hydrogenated feed gas which is arranged to be fed to the sulfur removal unit, and wherein said sulfur removal unit is arranged to receive said hydrogenated feed gas, and to provide a hydrogenated desulfurized feed gas to said prereformer unit as said first stream comprising hydrocarbons; said process further comprising a step of:
heating at least a portion of the hydrocarbon feed gas, by means of the superheated steam stream, before said feed gas is fed to the hydrogenation section.
